(19) United States
(12) Patent Application Publication
(10) Pub. No.: US 2017/0274762 A1
(43) Pub. Date: Sep. 28, 2017

(54) WORK VEHICLE

(71) Applicant: Komatsu Ltd., Tokyo (JP)

(72) Inventor: Kazuaki Takemura, Oyama-shi (JP)

(21) Appl. No.: 15/504,068

(22) PCT Filed: Mar. 25, 2016
(86) PCT No.: PCT/JP2016/059762

§ 371 Date: Feb. 15, 2017

(51) Int. Cl. B60K 15/063; B60R 3/00

(52) U.S. Cl. CPC B60K 15/063; B60R 3/00; B60R 16/04

(57) ABSTRACT

A work vehicle includes a front wheel, a rear wheel, a liquid tank, a front-wheel fender, a rear-wheel fender, a floor portion, and an electric-component room. The front wheel, the rear wheel, and the liquid tank are supported by a vehicle body. The front-wheel fender is disposed to surround a portion around the front wheel. The rear-wheel fender is disposed to surround a portion around the rear wheel. The floor portion is provided between a lower end portion of the front-wheel fender and a lower end portion of the rear-wheel fender. The electric-component room is provided on an upper surface of the floor portion, and houses electric components in a space formed with the floor portion. The electric-component room is disposed at an outer side of the liquid tank in a vehicle width direction of the vehicle body.

### FIELD

The present invention relates to a work vehicle.

### BACKGROUND

As disclosed in Patent Literature 1, a liquid tank such as a working-oil tank and a fuel tank is mounted on a work vehicle such as a forklift. In addition, a urea tank is mounted on a work vehicle that includes a urea selective catalytic reduction (SCR) system that purifies exhaust gas. Furthermore, electric components such as a battery, a fuse, a breaker, and a controller are mounted on a work vehicle.

### CITATION LIST

### Patent Literature

Patent Literature 1: Japanese Laid-open Patent Publication No. 2003-192284

### SUMMARY

### Technical Problem

A liquid tank and electric components need to be disposed in a limited space of a work vehicle. Depending on the layout of the liquid tank and the electric components, there is a possibility that, for example, the maintenance workability is reduced and the activation of a work vehicle is interfered.

An aspect of the present invention has an object to provide a work vehicle in which reduction in performance thereof is suppressed by optimally laying out a liquid tank and electric components.

### Solution to Problem

According to an aspect of the present invention, a work vehicle comprises: a front wheel supported by a vehicle body; a rear wheel supported by the vehicle body; a liquid tank supported by the vehicle body; a front-wheel fender disposed to surround a portion around the front wheel; a rear-wheel fender disposed to surround a portion around the rear wheel; a floor portion provided between a lower end portion of the front-wheel fender and a lower end portion of the rear-wheel fender; and an electric-component room that is provided on an upper surface of the floor portion, and houses electric components in a space formed with the floor portion, wherein the electric-component room is disposed at an outer side of the liquid tank in a vehicle width direction of the vehicle body.

### Advantageous Effects of Invention

According to an aspect of the present invention, there is provided a work vehicle in which reduction in performance thereof is suppressed by optimally laying out a liquid tank and electric components.

### BRIEF DESCRIPTION OF DRAWINGS

FIG. 1 is a perspective view illustrating an example of a work vehicle according to the present embodiment.

FIG. 2 is a perspective view illustrating an example of a housing member and a liquid tank according to the present embodiment.

FIG. 3 is a perspective view illustrating the example of the housing member and the liquid tank according to the present embodiment.

FIG. 4 is a cross-sectional view illustrating an example of the housing member and the liquid tank according to the present embodiment.

FIG. 5 is a perspective view illustrating an example of the housing member and the liquid tank according to the present embodiment.

### DESCRIPTION OF EMBODIMENTS

In the following, an embodiment according to the present invention will be described with reference to the drawings. However, the present invention is not limited to this embodiment. The components of the embodiment described below can optionally be combined. Furthermore, there may be a case where some of the components are not used.

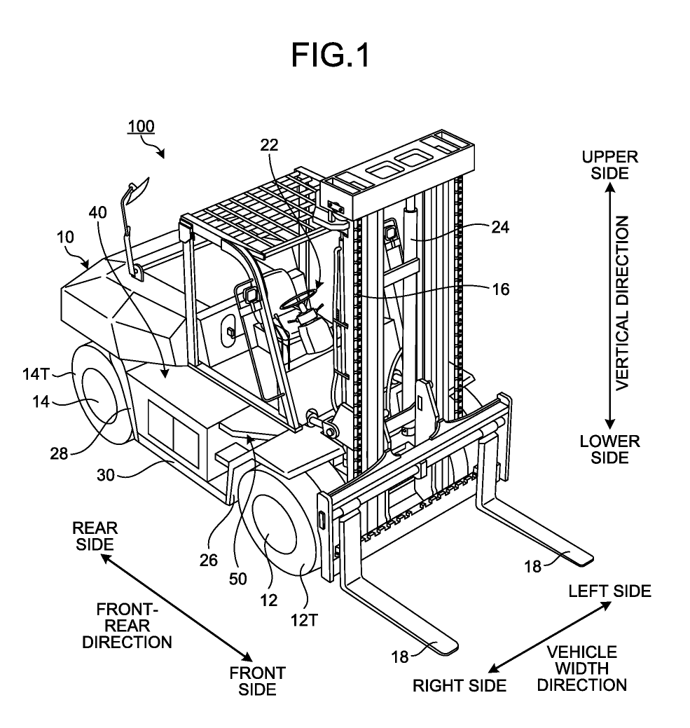

FIG. 1 is a perspective view illustrating an example of a work vehicle 100 according to the present embodiment. In the present embodiment, an example in which a forklift 100 is the work vehicle 100 will be described.

As illustrated in FIG. 1, the forklift 100 includes a vehicle body 10, a front wheel 12, a rear wheel 14, a mast 16, a fork 18, and a driver's seat 20. The front wheel 12, the rear wheel 14, the mast 16, and the driver's seat 20 are supported by the vehicle body 10. The fork 18 is supported by the mast 16.

The front wheel 12 and the rear wheel 14 are supported by the vehicle body 10 to be rotatable about the corresponding rotation axes. A tire 12T is mounted on the front wheel 12. A tire 14T is mounted on the rear wheel 14.

In the following description, a direction parallel to the rotation axes of the front wheel 12 and the rear wheel 14 when the forklift 100 travels straight is appropriately referred to as a vehicle width direction of the vehicle body 10. In addition, a direction parallel to a vertical axis orthogonal to the ground on which the tire 12T and the tire 14T travel is appropriately referred to as a vertical direction of the vehicle body 10. Moreover, a direction orthogonal to the rotation axes and to the vertical axis is appropriately referred to as a front-rear direction of the vehicle body 10.

In the present embodiment, based on a driver seated in the driver's seat 20, a direction in which the fork 18 exists is the front side, and a direction opposite to the front side is the rear side. One side in the vehicle width direction is the right side, and a direction opposite to the right side is the left side. The front wheel 12 is disposed in front of the rear wheel 14. The front wheel 12 is disposed on each side of the vehicle body 10 in the vehicle width direction. The rear wheel 14 is disposed on each side of the vehicle body 10 in the vehicle width direction.

The forklift 100 is operated by the driver seated on the driver's seat 20. An operating device 22 such as a steering wheel is disposed in front of the driver's seat 20. The driver activates the forklift 100 by operating the operating device 22.

The drive of a hydraulic cylinder 24 provided on the mast 16 causes the fork 18 to move in the vertical direction while being supported by the mast 16.

The vehicle body 10 includes a front-wheel fender 26 and a rear-wheel fender 28. The front-wheel fender 26 is disposed to surround a portion around the front wheel 12. The rear-wheel fender 28 is disposed to surround a portion around the rear wheel 14. The front-wheel fender 26 and the rear-wheel fender 28 function as mudguard members.

A floor portion 30 is provided between a lower end portion of the front-wheel fender 26 and a lower end portion of the rear-wheel fender 28. An electric-component room 700 where electric components are housed in a space formed with the floor portion 30 is provided on an upper surface of the floor portion 30.

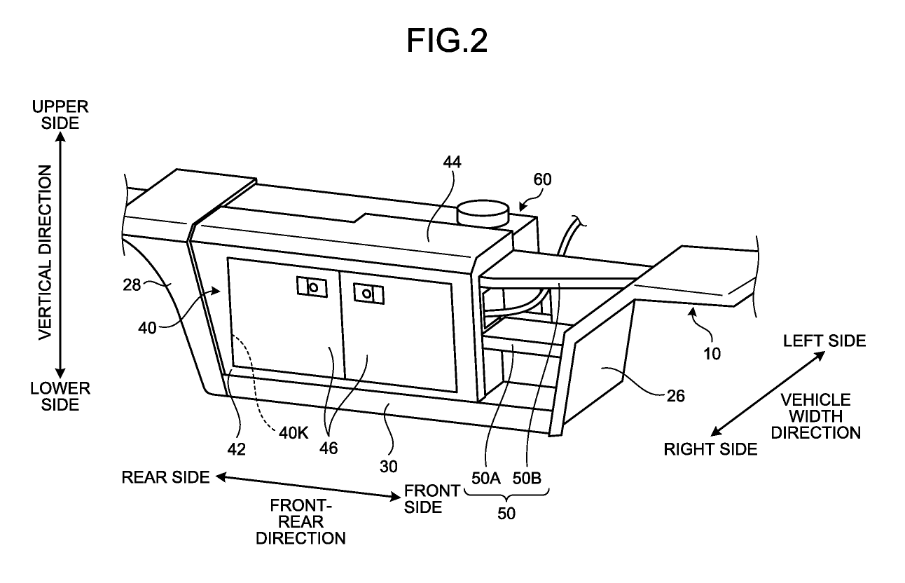

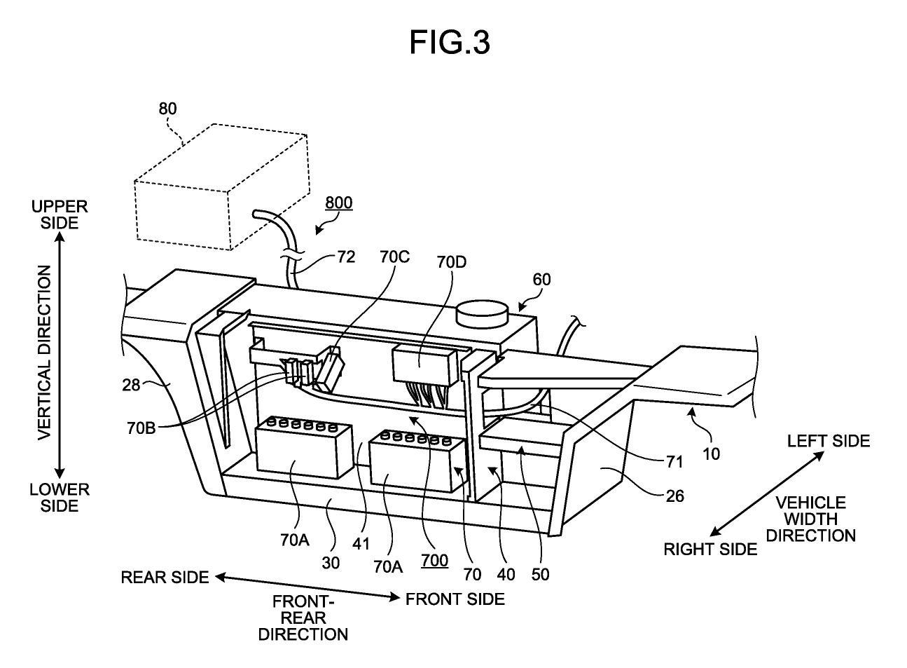

FIGS. 2 and 3 are perspective views illustrating an example of a housing member 40 and a liquid tank 60 according to the present embodiment. FIG. 2 illustrates the example of the housing member 40 and the liquid tank 60 provided on the right side of the vehicle body 10. FIG. 3 illustrates a portion of the housing member 40, which is illustrated in FIG. 2, being disassembled.

As illustrated in FIGS. 2 and 3, the forklift 100 includes the floor portion 30, the electric-component room 700, and the liquid tank 60. The floor portion 30 is provided between the lower end portion of the front-wheel fender 26 and the lower end portion of the rear-wheel fender 28. The electric-component room 700 is provided on the upper surface of the floor portion 30, and houses electric components 70 in the space formed with the floor portion 30. The liquid tank 60 is supported by the vehicle body 10. The electric-component room 700 is provided inside the housing member 40. In the vehicle width direction of the vehicle body 10, the electric-component room 700 is disposed at an outer side of the liquid tank 60.

The housing member 40 includes a main body 42, a cover member 44, and a door 46. The main body 42 includes a support plate 41. The cover member 44 is supported by the main body 42. The door 46 opens/closes a housing opening portion 40K of the electric-component room 700.

The main body 42 is fixed to the floor portion 30 using a fixing member such as a bolt. The support plate 41 includes a wall surface that supports the electric components 70. The wall surface of the support plate 41 faces an outer side in the vehicle width direction. In the example illustrated in FIGS. 2 and 3, the wall surface of the support plate 41 faces the right side. A back surface of the support plate 41, which faces an inner side in the vehicle width direction, faces the liquid tank 60.

An upper surface of the housing member 40 is formed of the cover member 44. The housing member 40 and the liquid tank 60 face each other via a gap therebetween. At least a portion of the cover member 44 is disposed above the gap between the housing member 40 and the liquid tank 60.

The housing member 40 includes the housing opening portion 40K. The housing opening portion 40K faces the outer side in the vehicle width direction. In the example illustrated in FIGS. 2 and 3, the housing opening portion 40K faces the right side. The door 46 opens/closes the housing opening portion 40K. In the present embodiment, two doors 46 are provided.

The electric components 70 include an electric device and an electronic device. In the present embodiment, the electric components 70 include a battery 70A, a fuse 70B, a breaker 70C, and a controller 70D. The battery 70A is supported by the upper surface of the floor portion 30. The fuse 70B, the breaker 70C, and the controller 70D are supported by the wall surface of the support plate 41. The electric components 70 described above are examples, and various types of electric components 70 are housed in the electric-component room 700.

The electric components 70 are connected to a signal-line cable 71 and an electric cable 72. The signal-line cable 71 and the electric cable 72 are each connected to various types of devices provided inside the vehicle body 10.

An engine room 800, where an engine 80 is housed, is provided inside the vehicle body 10. The engine 80 is disposed at a rear portion of the vehicle body 10. Among a plurality of the electric cables 72, at least a portion of the electric cables 72 is connected to the engine 80.

The liquid tank 60 is disposed at an inner side of the electric-component room 700 in the vehicle width direction. In the present embodiment, the liquid tank 60 is a working-oil tank where working oil is housed. The forklift 100 includes a plurality of hydraulic actuators such as a hydraulic cylinder 24 for driving the fork 18, a hydraulic motor for driving the front wheel 12 and/or the rear wheel 14, and a hydraulic pump. The working-oil tank houses the working oil supplied to the hydraulic actuators described above.

A dimension of the housing member 40 in the vehicle width direction is shorter than a dimension of the housing member 40 in the vertical direction. A dimension of the housing member 40 in the front-rear direction is longer than the dimensions of the housing member 40 in the vehicle width direction and in the vertical direction.

A dimension of the liquid tank 60 in the vehicle width direction is shorter than a dimension of the liquid tank 60 in the vertical direction. A dimension of the liquid tank 60 in the front-rear direction is longer than the dimensions of the liquid tank 60 in the vehicle width direction and in the vertical direction.

A height of the upper surface of the housing member 40 and a height of an upper surface of the liquid tank 60 are substantially the same. In addition, the dimension of the housing member 40 in the front-rear direction and the dimension of the liquid tank 60 in the front-rear direction are substantially the same. In the vertical direction and the front-rear direction, the housing member 40 and the liquid tank 60 are disposed at substantially the same position.

In the present embodiment, the housing member 40 is disposed so as to contact the rear-wheel fender 28. A step 50 is located between the housing member 40 and the front-wheel fender 26. The step 50 is used when the driver moves from the outside of the forklift 100 into the driver's seat 20, or when the driver moves from the driver's seat 20 to the outside of the forklift 100. In other words, by ascending/descending the step 50, the driver can move from the outside of the forklift 100 into the driver's seat 20, or move from the driver's seat 20 to the outside of the forklift 100.

A plurality of the steps 50 is provided. In the present embodiment, three steps 50 are provided. Among the plurality of steps 50, the step 50 provided at the lowest position also serves as the floor portion 30. In other words, the floor portion 30 is the step 50 provided at the lowest position. The step 50 includes a first step 50A and a second step 50B. The first step 50A is disposed above the floor portion 30. The second step 50B is disposed above the first step 50A. The second step 50B is supported by the vehicle body 10. The first step 50A is supported by the housing member 40 and the front-wheel fender 26. A gap is formed between the second step 50B and the housing member 40. As a result, a dimensional error of the housing member 40 or a dimensional error of the second step 50B is allowable. The first step 50A is detachably fixed to the housing member 40 using a fixing member such as a bolt. In addition, the first step 50A is replaceable.

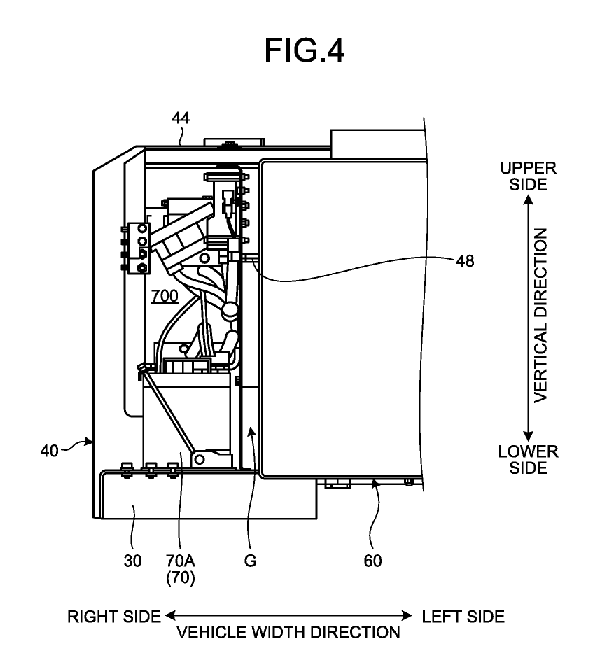

FIG. 4 is a cross-sectional view illustrating an example of the housing member 40 and the liquid tank 60 according to the present embodiment. FIG. 4 corresponds to a cross-sectional view of the housing member 40 and the liquid tank 60 as viewed from the front.

As illustrated in FIG. 4, a partition wall 48 is disposed between the electric-component room 700 and the liquid tank 60. The partition wall 48 is disposed between the back surface of the support plate 41 and a front surface of the liquid tank 60 that faces the back surface of the support plate 41. By disposing the partition wall 48, the electric-component room 700 and the liquid tank 60 face each other via a gap G.

At least a portion of the cover member 44 is disposed above the gap G. The cover member 44 covers the gap G.

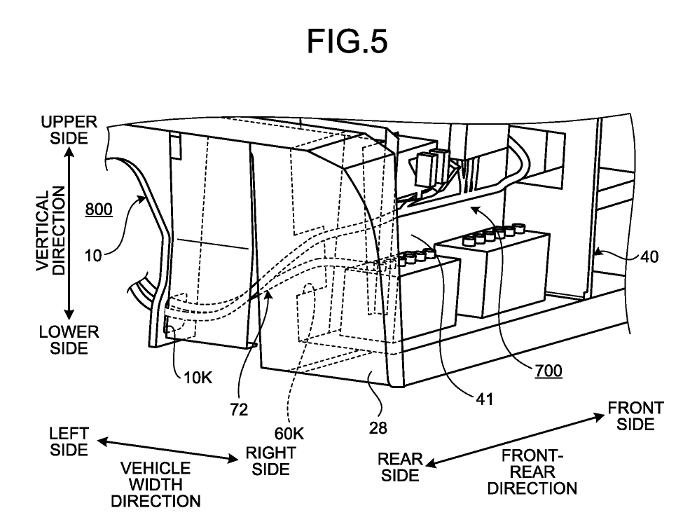

FIG. 5 is a perspective view illustrating the housing member 40 and the liquid tank according to the present embodiment as viewed from behind. An electric-cable inserting portion 60K, into which the electric cable 72 is inserted, is provided at a rear portion of the liquid tank. In addition, an opening portion 10K, where the electric cable 72 is disposed, is provided on the vehicle body 10.

The vehicle body 10 includes the engine room 800 where the engine 80 is housed. The engine room 800 provided in the vehicle body 10 and the electric-component room 700 provided in the housing member 40 are connected to each other via the electric-cable inserting portion 60K and the opening portion 10K. The electric cable 72 connects the electric components 70 (such as the battery 70A), which are provided in the electric-component room 700, and the engine 80.

As described above, according to the present embodiment, the electric-component room 700 that houses the electric components 70, and the liquid tank 60 are disposed adjacent to each other in the vehicle width direction. In addition, in the vehicle width direction, the electric-component room 700 is disposed on the outer side of the liquid tank 60. Therefore, the maintenance workability of the electric components 70 is improved. The electric-component room 700 is provided on the upper surface of the floor portion 30 provided between the lower end portion of the front-wheel fender 26 and the lower end portion of the rear-wheel fender 28. Accordingly, no other members or devices exist at an outer side of the electric-component room 700 in the vehicle width direction. As a result, a worker can smoothly access from the outside of the forklift 100 to the electric-component room 700. Moreover, the worker can smoothly carry out the maintenance of the electric components 70. Since the maintenance of the electric components 70 is carried out sufficiently, the electric device or the electronic device provided on the forklift 100 is activated properly. Consequently, the interference in the activation of the forklift 100 is suppressed and thus, the reduction in performance of the forklift 100 is suppressed.

According to the present embodiment, the electric-component room 700 and the liquid tank 60 are disposed adjacent to each other. In addition, the dimension of the housing member 40 in the vehicle width direction is shorter than the dimension of the housing member 40 in the vertical direction. Moreover, the dimension of the liquid tank 60 in the vehicle width direction is shorter than the dimension of the liquid tank 60 in the vertical direction. As a result, a space in the vehicle body 10 can be used effectively. Furthermore, the height of the liquid tank 60 can be heightened; therefore, the working oil is smoothly supplied from the liquid tank 60 to the hydraulic actuators.

According to the present embodiment, the step 50 is located between the housing member 40 and the front-wheel fender 26. Therefore, at the front of the vehicle body 10, the driver can get on the driver's seat 20 or get off the driver's seat 20 using the step 50.

In addition, according to the present embodiment, the floor portion 30, the first step 50A, and the second step 50B are provided. The floor portion 30 is the step 50 disposed at the lowest position. The first step 50A is disposed above the floor portion 30. The second step 50B is disposed above the first step 50A. The driver can get on the driver's seat 20 or get off the driver's seat 20 using the plurality of steps 50 including the floor portion 30. The floor portion 30 also serves as the step 50; therefore, the amount of members used for the steps 50 can be suppressed.

According to the present embodiment, the partition wall 48 is disposed between the electric-component room 700 and the liquid tank 60, and the gap G is formed between the support plate 41 and the liquid tank 60. Even if the working oil housed in the liquid tank 60 causes the temperature in the liquid tank 60 to rise, the gap G is provided and thus, the transmission of heat in the liquid tank 60 to the electric-component room 700 is suppressed. In addition, flow of air into the gap G causes the rise in temperature in the electric-component room 700 to be suppressed. Consequently, the rise in temperature of the electric components 70 is suppressed and thus, the reduction in the performance of the electric components 70 is suppressed.

Moreover, according to the present embodiment, the cover member 44 is disposed above the gap G. As a result, entry of foreign matters such as rainwater or dust to the gap G is suppressed.

Furthermore, according to the present embodiment, the electric-cable inserting portion 60K is provided at the rear portion of the liquid tank 60, and the electric cable 72 for supplying electric power to the engine 80 is inserted into the electric-cable inserting portion 60K. In other words, the electric cable 72 connected to the battery 70A is disposed in the engine room 800 via the electric-cable inserting portion 60K, and is connected to the engine 80. An electric resistance value increases when the electric cable 72 becomes long. Accordingly, when the electric cable 72 becomes long, there is a possibility that a value of the electric power supplied to the engine 80 decreases and thus, for example, the startup performance of the engine 80 reduces. Therefore, it is preferable that the electric cable 72 be short. According to the present embodiment, the electric-cable inserting portion 60K is provided in the liquid tank 60 disposed adjacent to the electric-component room 700 that houses the battery 70A; therefore, there is no need to widely pull around the electric cable 72. Consequently, even if the electric cable 72 is shortened, the battery 70A and the engine 80 can be connected to each other.

In the technical field relating to the forklift 100, the engine 80 is disposed at the rear portion of the vehicle body 10 in many cases. In the present embodiment, the electric-cable inserting portion 60K is formed at the rear portion of the liquid tank 60. As a result, even if the electric cable 72 is shortened as much as possible, the battery 70A and the engine 80 can be connected to each other.

According to the present embodiment, in the electric-component room 700, the housing opening portion 40K that faces the outer side in the vehicle width direction is provided. Therefore, the worker can smoothly carry out the maintenance of the electric components 70 disposed in the electric-component room 700 via the housing opening portion 40K. Moreover, by disposing the door 46 at the housing opening portion 40K, the electric components 70 in the electric-component room 700 are protected by the door 46.

In the embodiment described above, the liquid tank 60 has been the working-oil tank. However, the liquid tank 60 may be a fuel tank or a urea tank.

In addition, in the embodiment described above, the work vehicle 100 has been the forklift 100. However, the components described in the embodiment above can be applied to a work vehicle that includes a front wheel and a rear wheel. For example, the work vehicle 100 may be a wheel loader.

### REFERENCE SIGNS LIST

10 Vehicle body

10K Opening portion

12 Front wheel

12T Tire

14 Rear wheel

14T Tire

16 Mast

18 Fork

20 Driver's seat

22 Operating device

24 Hydraulic cylinder

26 Front-wheel fender

28 Rear-wheel fender

30 Floor portion

40 Housing member

40K Housing opening portion

41 Support plate

42 Main body

44 Cover member

46 Door

48 Partition wall

50 Step

50A First step

50B Second step

60 Liquid tank

60K Electric-cable inserting portion

70 Electric component

70A Battery

70B Fuse

70C Breaker

70D Controller

71 Signal-line cable

72 Electric cable

80 Engine

100 Forklift (work vehicle)

700 Electric-component room

800 Engine room

1. A work vehicle comprising:
a front wheel supported by a vehicle body;
a rear wheel supported by the vehicle body;
a liquid tank supported by the vehicle body;
a front-wheel fender disposed to surround a portion around the front wheel;
a rear-wheel fender disposed to surround a portion around the rear wheel;
a floor portion provided between a lower end portion of the front-wheel fender and a lower end portion of the rear-wheel fender; and
an electric-component room that is provided on an upper surface of the floor portion, and houses electric components in a space formed with the floor portion, wherein
the electric-component room is disposed at an outer side of the liquid tank in a vehicle width direction of the vehicle body.

2. The work vehicle according to claim 1, comprising
a step located between the electric-component room and the front-wheel fender.

3. The work vehicle according to claim 2, wherein
a plurality of the steps is provided, and among the plurality of steps, a step provided at the lowest position also serves as the floor portion.

4. The work vehicle according to claim 1, comprising
a partition wall between the electric-component room and the liquid tank.

5. The work vehicle according to claim 4, wherein
the electric-component room and the liquid tank face each other via a gap formed therebetween by the partition wall, and
the work vehicle comprises a cover member disposed above the gap.

6. The work vehicle according to claim 1, wherein
an electric-cable inserting portion, into which an electric cable connected to the electric components is inserted, is provided at a rear portion of the liquid tank, and
an engine room and the electric-component room which are provided in the vehicle body are connected to each other via the electric-cable inserting portion.

7. The work vehicle according to claim 1, comprising
a door that opens/closes a housing opening portion of the electric-component room that faces an outer side in the vehicle width direction.
